(19) United States
(12) Patent Application Publication
(10) Pub. No.: US 2014/0179241 A1
(43) Pub. Date: Jun. 26, 2014

(54) CONCURRENT MATCHING NETWORK USING TRANSMISSION LINES FOR LOW LOSS

(71) Applicant: Qualcomm Incorporated, (US)

(72) Inventors: Kamal Aggarwal, Sunnyvale, CA (US); Mounir Y. Bohsali, San Jose, CA (US); Mazhareddin Taghivand, Campbell, CA (US)

(73) Assignee: QUALCOMM Incorporated, San Diego, CA (US)

(21) Appl. No.: 13/722,668

(22) Filed: Dec. 20, 2012

(51) Int. Cl. H04B 1/44

(52) U.S. Cl. CPC H04B 1/44
USPC 455/83

(57) ABSTRACT

A concurrent matching network using transmission lines for low loss is disclosed. In an exemplary embodiment, an apparatus includes a first ¼ wavelength transmission line configured to couple a first signal path to a common node that is coupled to one or more additional signal paths. The apparatus also includes at least one switch configured to disable the first signal path causing the first ¼ wavelength transmission line to provide a first off-state impedance at the common node.

### BACKGROUND

1. Field

The present application relates generally to the operation and design of analog front ends, and more particularly, to the operation and design of concurrent matching networks for use in analog front ends.

2. Background

In transceivers, it is desirable to share an antenna between a receiver (Rx) and a transmitter (Tx), which can result in a substantial area savings that reduce the cost of the overall system. However, conventional sharing mechanisms may be very lossy and can degrade the overall performance of the system. For example, one way to address this issue is to use two switches, one switch is placed between the antenna and the Tx while the other switch is placed between the antenna and the Rx. These switches are then turned ON or OFF depending on the operating mode. For example, a MOS device configured as a pass gate is usually inserted between the antenna and a low noise amplifier (LNA) input of the Rx. A similar switching device is placed between the output of a power amplifier (PA) of the Tx and the antenna. When the PA needs to transmit, the LNA switch is turned OFF and when the LNA needs to receive, the PA switch is turned OFF. This configuration works but it introduces loss as these switches are in series with the signal paths. In order to reduce the series loss, the size of the switches can be increased; however, the resulting OFF capacitance of the switches also increases with size and can degrade the bandwidth of the system.

Accordingly, what is needed is a mechanism to share an antenna that reduces or eliminates switch loss and that avoids undesired capacitance that may degrade system bandwidth.

### BRIEF DESCRIPTION OF THE DRAWINGS

The foregoing aspects described herein will become more readily apparent by reference to the following description when taken in conjunction with the accompanying drawings wherein:

FIG. 1 shows a transceiver portion that comprises an exemplary embodiment of a concurrent matching network for Tx/Rx antenna sharing;

FIG. 2 shows an exemplary detailed embodiment of the concurrent matching network shown in FIG. 1;

FIG. 3 shows an exemplary embodiment of the concurrent matching network shown in FIG. 2 during a transmit mode;

FIG. 4 shows an exemplary embodiment of the concurrent matching network shown in FIG. 2 during a receive mode; and

FIG. 5 shows an exemplary embodiment of a concurrent matching network configured for use with a plurality of signal branches; and

FIG. 6 shows an exemplary embodiment of a concurrent matching network apparatus.

### DETAILED DESCRIPTION

The detailed description set forth below in connection with the appended drawings is intended as a description of exemplary embodiments of the invention and is not intended to represent the only embodiments in which the invention can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. It will be apparent to those skilled in the art that the exemplary embodiments of the invention may be practiced without these specific details. In some instances, well known structures and devices are shown in block diagram form in order to avoid obscuring the novelty of the exemplary embodiments presented herein.

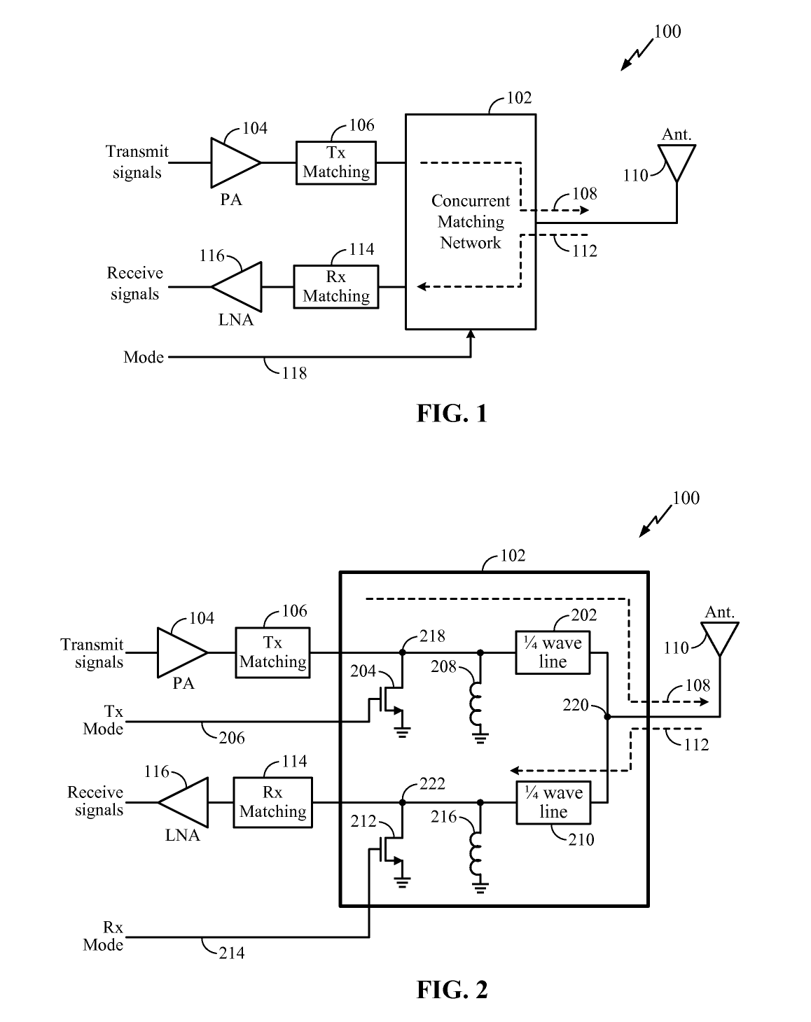

FIG. 1 shows a transceiver portion 100 that comprises an exemplary embodiment of a concurrent matching network 102 for Tx/Rx antenna sharing in a device. The matching network 102 operates to connect a Tx path 108 and an Rx path 112 to antenna 110. A power amplifier (PA) 114 that is part of a transmitter is configured to amplify an transmit signal and output an amplified transmit signal to a Tx matching circuit 106 that provides the optimum input impedance (as seen by the PA 114) to input signals to the concurrent matching network 102. The concurrent matching network 102 provides the amplified transmit signal to the antenna 110.

Signals received by the antenna 110 are provided to the Rx matching circuit 114 that provides the optimum input impedance to input the received signals to an LNA 116 that is part of a receiver. The LNA 116 amplifies the signal at its input to generate a received signal. A mode signal 118 from another entity at the device, such as a baseband processor, controls the concurrent matching network 102 to enable either the transmit path 108 or the receive path 112. In various exemplary embodiments disclosed below, the concurrent matching network 102 operates to provide low loss concurrent matching to the antenna 102 without the use of series switches.

FIG. 2 shows an exemplary detailed embodiment of the concurrent matching network 102. As shown in FIG. 2, the output of the Tx matching circuit 106 is connected to an input of the concurrent matching network at node 218. A ¼ wavelength transmission line 202 is connected between the node 208 and a common node 220, which is further connected to the antenna 110. A switch 204 is also connected to the node 218 and is configured to selectively couple or decouple the node 218 to ground thereby disabling or enabling the transmit signal path 108, respectively. The switch 204 is controlled by a Tx mode control signal 206. An optional inductor 208 is also connected to the node 218 to provide electro-static discharge (ESD) protection.

A second ¼ wavelength transmission line 210 is connected between the common node 220 and node 222. The node 222 is connected to the input of the Rx matching circuit 114. A switch 212 is also connected to the node 222 and is configured to selectively couple or decouple the node 222 to ground thereby disabling or enabling the receive signal path 112, respectively. The switch 212 is controlled by an Rx mode control signal 214. An optional inductor 216 is also connected to the node 222 to provide electro-static discharge (ESD) protection. In an exemplary embodiment, the transmission lines 210, 202 can be implemented using Co-planar waveguides (CPW) lines or micro-strip line (MSL) and the switches 212, 204 can be implemented using MOS devices.

During operation, the mode control signals 206, 214 operate to control the switches 204, 212, respectively, to enable or disable their associated signal paths. As will be discussed in further detail below, when one signal path is disabled, it is placed in an off-state that does not consume power or provide loss to the enabled signal path.

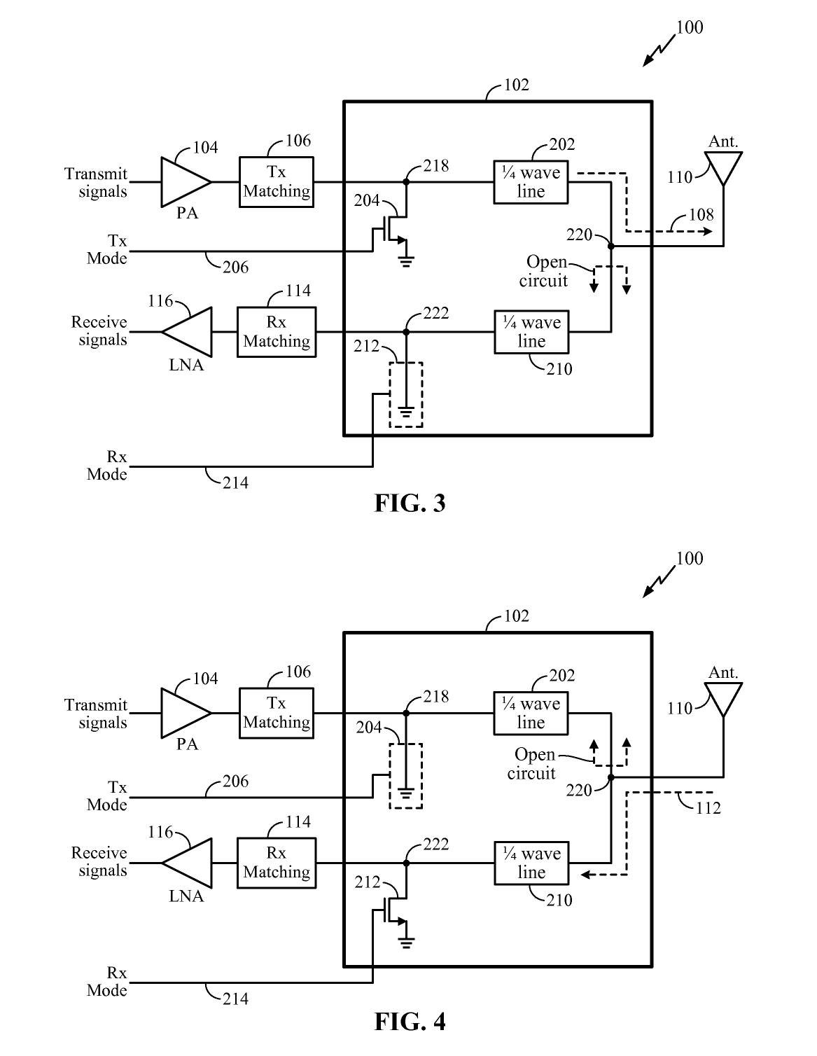

FIG. 3 shows the concurrent matching circuit 102 during operation in a transmit mode. In this mode, the Tx mode control signal 206 controls the switch 204 to decouple the node 218 from ground thereby enabling the transmit signal path 108. With the transmit signal path 108 enabled, transmit signals can flow from the PA 104 through the Tx matching circuit 106 and through the transmission line 202 to the antenna 110. For example, in an exemplary embodiment, the transmit signals are signals in the millimeter (MM) wavelength frequency range. In this mode, the ¼ wave transmission line 202 provides an on-state matching impedance as seen from the common node 220. In an exemplary embodiment, the on-state matching impedance provided by the ¼ wave transmission line 202 is 50 ohms.

The Rx mode control signal 214 controls the switch 212 to couple the node 222 to ground thereby disabling the receive signal path. The switch 212 presents some capacitive load which is absorbed in the Rx matching circuit 114. With the switch 212 providing a ground connection, the transmission line 210 provides a very high off-state impedance that acts effectively as an open circuit that disconnects the ¼ wave transmission line 210 from the transmit signal path 108 at the common node 220. In an exemplary embodiment, the high off-state impedance causes less than 3 dB of signal loss to signals flowing in the transmit signal path 108. In an exemplary embodiment, the high off-state impedance results in only 1 dB or less of signal loss to signals flowing in the transmit signal path 108.

Thus, the transmission line 210 in the receive signal path provides little or no signal loss to the transmit signals in the transmit signal path 108 during transmit mode operation. For example, with the ¼ wave transmission line 210 disabled, signals in the transmit signal path 108 are substantially prevented from flowing in the received signal path due to the high off-state impedance (i.e., effective open circuit) provided by the ¼ wave transmission line 210.

FIG. 4 shows the concurrent matching circuit 102 during operation in a receive mode. In this mode, the Rx mode control signal 214 controls the switch 212 to decouple the node 222 from ground thereby enabling the receive signal path 112. With the receive signal path 112 enabled, received signals can flow from the antenna 110 through the transmission line 210 and the Rx matching circuit 114 to the input of the LNA 116. For example, in an exemplary embodiment, the received signals are signals in the millimeter (MM) wavelength frequency range. In this mode the ¼ wave transmission line 210 provides an on-state matching impedance as seen from the common node 220. In an exemplary embodiment, the on-state matching impedance provided by the ¼ wave transmission line 210 is 50 ohms.

The Tx mode control signal 206 controls the switch 204 to couple the node 218 to ground thereby disabling the transmit signal path. The switch 204 presents some capacitive load which is absorbed in the Tx matching circuit 106. With the switch 204 providing a ground connection, the transmission line 202 provides a very high off-state impedance that acts effectively as an open circuit that disconnects the ¼ wave transmission line 202 from the receive signal path 112. In an exemplary embodiment, the high off-state impedance causes less than 3 dB of signal loss to signals flowing in the receive signal path 112. In an exemplary embodiment, the high off-state impedance results in only 1 dB or less of signal loss to signals flowing in the receive signal path 112.

Thus, the transmission line 202 in the transmit signal path provides little or no signal loss to the received signals in the receive signal path 112 during receive mode operation. For example, with the ¼ wave transmission line 202 disabled, signals in the receive signal path 112 are substantially prevented from flowing in the transmit signal path due to the high off-state impedance (i.e., effective open circuit) provided by the ¼ wave transmission line 202.

Thus, in various exemplary embodiments, the concurrent matching network 102 provides a two-branch network having a common node 220 connected to the antenna 110. A transmit branch (transmission line 202) of the network 102 is connected between the switch 204 and the connection to the antenna 110 at node 220, while a receive branch (transmission line 210) is connected between the switch 212 and the connection to the antenna 110 at node 220. These branches provide low loss signal paths to the antenna when the branches are enabled. When either branch is grounded, using the switches 204 and 212, the associated transmission line acts effectively as an open circuit as seen from the node 220 and therefore reduces or eliminates signal loss to signals flowing in the enabled signal branch. In general, any number of branches can be connected to a common node (i.e., node 220) and then decoupled from each other using the exemplary embodiments without affecting the performance of the enabled branch.

The ¼ wavelength transmission lines 202, 210 are designed to operate at the frequency of interest and can be implemented using a top metal layer which is very thick and hence provides very low loss when compared to the conventional solution implemented using a series connected transistor, which relies on a transistor channel impedance that has more loss. If the characteristic impedance of the ¼ wavelength transmission lines 202 is the same as the load impedance (i.e., 50 ohms), it does not alter the impedance seen by the PA 104 and hence preserves the PA output matching. If the characteristic impedance of the ¼ wavelength transmission line 210 is the same as the input impedance (i.e., 50 ohms), it does not alter the impedance seen by the LNA 116 and hence preserves the LNA input matching.

In an alternative embodiment, an LC-tuned network coupled to a switch to ground can also be used to emulate the behavior of the ¼ wave transmission lines 202, 210 at lower frequencies where the wavelength is prohibitively long to implement as transmissions lines on chip.

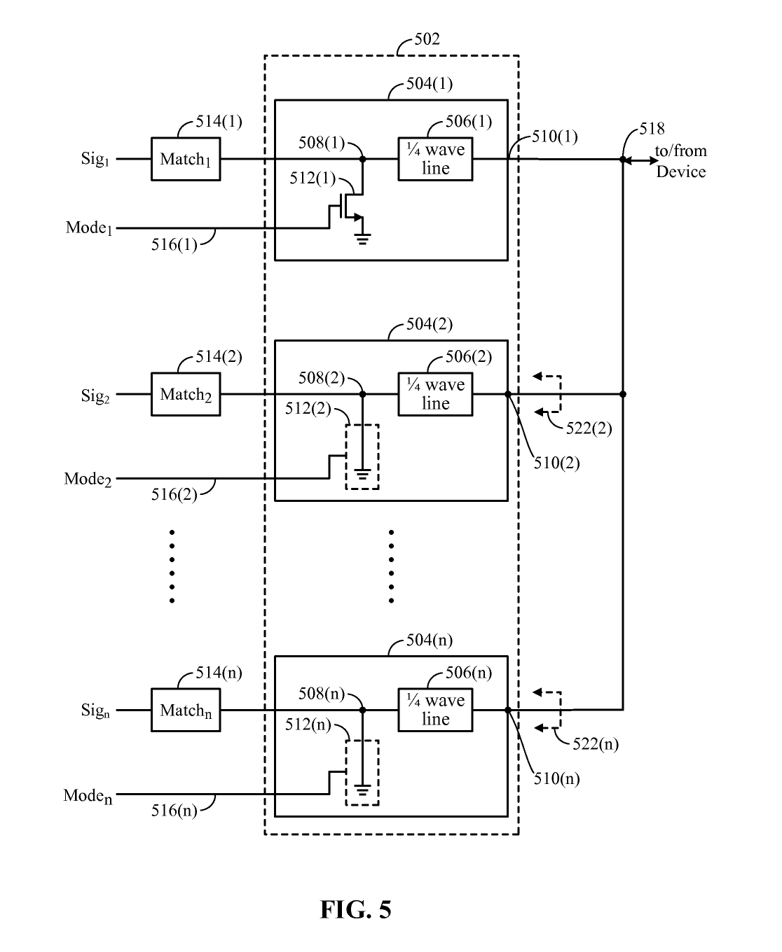

FIG. 5 shows an exemplary embodiment of a concurrent matching network 502 comprising signal branches 504(1−n). The concurrent matching network 502 is configured so that each signal branch is coupled to a common node 518, which may be further coupled to an antenna or other functional module such as an LNA, PA, or other device.

Each signal branch 504 comprises ¼ wavelength transmission line 506 connected between a first node 508 and a second node 510. The second nodes 510 are connected to the common node 518. Each signal branch 504 also comprises a switch 512 connected between the first node 508 and ground. The switches 512 are configured to coupled or decouple the first node 508 to ground in response to a mode control signal 516. When a branch 504 is enabled (on-state), its corresponding mode control signal 516 controls the associated switch 512 to decouple the first node 508 from ground. When a branch is disabled (off-state), its corresponding mode control signal 516 controls the associated switch 512 to couple the first node 508 to ground.

Signals (Sig₁₋ₙ) are connected to corresponding matching circuits 514. The matching circuits 514 provide the appropriate impedance matching. The matching circuits are connected to the nodes 508. Each branch 504 either directs a signal to the common node 518 or receives a signal from the common node 518.

During operation, the mode control signals 516 are generated by some device entity, such as a baseband processor, and operate to control the switches 512 to either enable or disable the branches 504. For example, the branch 504(1) is enabled so that the Sig₁ signal can flow across the transmission line 506(1) in the desired direction. The other branches 504(2) through 504(n) are disabled, so that they provide a high off-state impedance (i.e., an effective open circuit as illustrated at 522), as seen by the common node 518. This means that these disabled branches will not result in any power loss to signals flowing in the enabled branch 504(1) as these signals will be prevented from flowing in the disabled signal branches. Accordingly, any number of branches may be connected to the common node 518. Any branch that is enabled will experience little or no signal loss due to any of the disabled branches. Thus, the concurrent matching network 502 operates to couple/decouple multiple signal branches (i.e., n signal branches) connected to the common node 518, to allow one enabled signal branch to pass signals with little or no signal loss attributable to the disabled branches. In exemplary embodiments, the common node 518 is coupled to an antenna or other functional device, such as an LNA or PA.

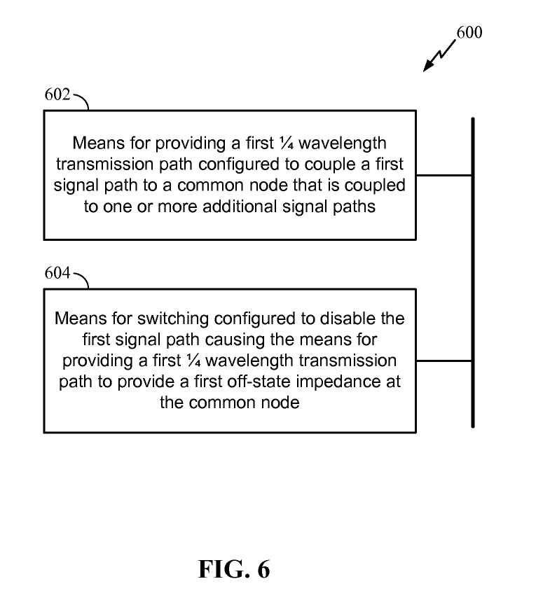

FIG. 6 shows an exemplary embodiment of a concurrent matching network apparatus 600. For example, the apparatus 600 is suitable for as the matching network 102 shown in FIG. 2. In an aspect, the apparatus 600 is implemented by one or more modules configured to provide the functions as described herein. For example, in an aspect, each module comprises hardware and/or hardware executing software.

The apparatus 600 comprises a first module comprising means (602) for providing a first ¼ wavelength transmission path configured to couple a first signal path to a common node that is coupled to one or more additional signal paths, which in an aspect comprises the transmission line 202.

The apparatus 600 comprises a second module comprising means (604) for switching configured to disable the first signal path causing the means for providing a first ¼ wavelength transmission path to provide a first off-state impedance at the common node. In an aspect, the means for switching comprises the switch 204.

Those of skill in the art would understand that information and signals may be represented or processed using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof. It is further noted that transistor types and technologies may be substituted, rearranged or otherwise modified to achieve the same results. For example, circuits shown utilizing PMOS transistors may be modified to use NMOS transistors and vice versa. Thus, the amplifiers disclosed herein may be realized using a variety of transistor types and technologies and are not limited to those transistor types and technologies illustrated in the Drawings. For example, transistors types such as BJT, GaAs, MOSFET or any other transistor technology may be used.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both non-transitory computer storage media and communication media including any medium that facilitates transfer of a computer program from one place to another. A non-transitory storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The description of the disclosed exemplary embodiments is provided to enable any person skilled in the art to make or use the invention. Various modifications to these exemplary embodiments will be readily apparent to those skilled in the art, and the generic principles defined herein may be applied to other embodiments without departing from the spirit or scope of the invention. Thus, the invention is not intended to be limited to the exemplary embodiments shown herein but is to be accorded the widest scope consistent with the principles and novel features disclosed herein.

What is claimed is:

1. An apparatus comprising:
a first ¼ wavelength transmission line configured to couple a first signal path to a common node that is coupled to one or more additional signal paths; and
at least one switch configured to disable the first signal path causing the first ¼ wavelength transmission line to provide a first off-state impedance at the common node.

2. The apparatus of claim 1, the first off-state impedance configured to cause less than 3 dB of signal loss to signals flowing in the one or more additional signal paths.

3. The apparatus of claim 1, the at least one switch configured to enable the first signal path causing the first ¼ wavelength transmission line to provide a first on-state impedance selected for impedance matching to the common node.

4. The apparatus of claim 3, the one or more additional signal paths comprising a second ¼ wavelength transmission line configured to couple a second signal path to the common node.

5. The apparatus of claim 4, the at least one switch configured to disable the second signal path and enable the first signal path causing the second ¼ wavelength transmission line to provide a second off-state impedance at the common node, the second off-state impedance configured to cause less than 3 dB of signal loss to signals flowing in the first signal path.

6. The apparatus of claim 5, the at least one switch configured to enable the second signal path causing the second ¼ wavelength transmission line to provide a second on-state impedance selected for impedance matching to the common node.

7. The apparatus of claim 4, the first signal path is a transmit signal path and the second signal path is a receive signal path.

8. The apparatus of claim 4, the first signal path is coupled to an output of a first amplifier and the second signal path is coupled to an input of a second amplifier.

9. The apparatus of claim 4, the at least one switch comprising a first switch configured to couple a first node to a ground to disable the first signal path and to couple a second node to the ground to disable the second signal path.

10. The apparatus of claim 4, further comprising:
at least one additional ¼ wavelength transmission line configured to couple at least one additional signal path to the common node; and
the at least one switch further configured to disable the at least one additional signal path causing the at least one additional ¼ wavelength transmission line to provide a selected off-state impedance at the common node.

11. The apparatus of claim 4, the apparatus configured to provide concurrent matching to an antenna that is connected to the common node.

12. An apparatus comprising:
means for providing a first ¼ wavelength transmission path configured to couple a first signal path to a common node that is coupled to one or more additional signal paths; and
means for switching configured to disable the first signal path causing the means for providing a first ¼ wavelength transmission path to provide a first off-state impedance at the common node.

13. The apparatus of claim 12, the first off-state impedance configured to cause less than 3 dB of signal loss to signals flowing in the one or more additional signal paths.

14. The apparatus of claim 12, the means for switching configured to enable the first signal path causing the means for providing a first ¼ wavelength transmission path to provide a first on-state impedance selected for impedance matching to the common node.

15. The apparatus of claim 12, the one or more additional signal paths comprising a means for providing a second ¼ wavelength transmission path configured to couple a second signal path to the common node.

16. The apparatus of claim 15, the means for switching configured to disable the second signal path and enable the first signal path causing the means for providing a second ¼ wavelength transmission path to provide a second off-state impedance at the common node, the second off-state impedance configured to cause less than 3 dB of signal loss to signals flowing in the first signal path.

17. The apparatus of claim 15, the means for switching configured to enable the second signal path causing the means for providing a second ¼ wavelength transmission path to provide a second on-state impedance selected for impedance matching to the common node.

18. The apparatus of claim 15, the first signal path is a transmit signal path and the second signal path is a receive signal path.

19. The apparatus of claim 15, further comprising:
means for providing at least one additional ¼ wavelength transmission path configured to couple at least one additional signal path to the common node; and
the means for switching further configured to disable the at least one additional signal path causing the means for providing at least one additional ¼ wavelength transmission path to provide a selected off-state impedance at the common node.

20. The apparatus of claim 15, the apparatus configured to provide concurrent matching to an antenna that is connected to the common node.
